(19) United States
(12) Patent Application Publication
(10) Pub. No.: US 2009/0199120 A1
(43) Pub. Date: Aug. 6, 2009

(54) Customizable, reconfigurable graphical user interface

(75) Inventors: Paul Edward Baxter, Newtonville, MA (US); Brian M. Looney, Lexington, MA (US); John J. McDonald, Lynnfield, MA (US); Anthony Caravello, Norwood, MA (US)

Correspondence Address: CESARI AND MCKENNA, LLP, 88 BLACK FALCON AVENUE, BOSTON, MA, 02210, US

(73) Assignee: MOAEC, Inc., Billerica, MA (US)

(21) Appl. No.: 12/286,095

(22) Filed: Sep. 26, 2008

Related U.S. Application Data
(60) Provisional application No. 61/063,262, filed on Feb. 1, 2008.

(51) Int. Cl. G06F 3/048

(52) U.S. Cl. 715/765; 715/764

(57) ABSTRACT

A graphical user interface (“GUI”) for a software-controlled media/data organizer and playback system including a display screen with a plurality of user-activatible search and selection buttons for use in accessing the media/data selections from one or more storage devices. The GUI, when started on a suitable system, automatically senses the system's display screen size and automatically configures the GUI buttons, windows and other characteristics of the display to conform thereto. The GUI also enables the user to configure and customize the GUI buttons, windows and other display characteristics to suit his/her particular needs and preferences. Additionally, the GUI includes an improved asynchronous media/data selection search facility that displays in a GUI search window, substantially immediately, the initial results of a search request while additional searching proceeds asynchronously “behind the scenes” until the follow-on results are ready for display. The search facility is also adopted to account for misspellings, date transposition and other errors and other errors made by the user during entry of search requests. Other improved features of the GUI include its ability to merge or synchronize the search and selection buttons and media/data selections among different systems and the ability to monitor and report details of a user's activity on a given system.

### RELATED APPLICATION

This application claims priority to U.S. Provisional Patent Application Ser. No. 61/063,262, entitled, CUSTOMIZABLE, RECONFIGUREABLE GRAPHICAL USER INTERFACE by Paul E. Baxter, et al, which was filed on Feb. 1, 2008, the contents of which are incorporated herein by reference.

### COMPUTER PROGRAM LISTING APPENDIX

Submitted herewith are two duplicate compact disks containing program listings in C# computer programming language and the Perl computer programming language of source code and associated files implementing an exemplary, Windows-based system embodied in accordance with an illustrative embodiment of the present invention. The contents of the compact disk are incorporated herein by reference in their entirety.

The appended source code is subject to copyright protection. The copyright owner has no objection to the reproduction of the patent document or the patent disclosure, as it appears in the Patent and Trademark Office patent file or records, for the purpose of assessing the patent and its claims, but otherwise reserves all copyright rights whatsoever with respect to the submitted code.

### FIELD OF THE INVENTION

The present invention relates to a graphic user interface and, more particularly, to a graphical user interface for a media/data selection organizer and playback system which includes a display screen and which can be customized and reconfigured, either automatically or manually, depending on the display screen size, environment of use and other characteristics of the organizer and playback system with which the interface is associated.

### BACKGROUND OF THE INVENTION

U.S. Pat. No. 7,205,471 (the “'471 patent”) discloses a system that can be used to access any of a wide variety of media/data selections stored in one or more remote (e.g., Internet-accessible) or local (e.g., hard drive) storage devices. The system can organize the media/data selections in playlists based on user specified categories and sub-categories applicable to the selections, and then display or play the selections back on a suitable display or playback device. The media/data selections accessible by the system may include, without limitation, songs, videos, audio presentations, photographs, advertisements, books, documents, and any other media/data capable of being stored and retrieved electronically.

A user controls the system using a graphical user interface (“GUI”). The GUI is preferably in the form of a display with a plurality of user selectable “buttons” which may be activated using a computer cursor, by touch screen activation, voice recognition activation or any other state of the art activation. The GUI displays a first plurality of main category buttons for the media/data selections, each of which may, for example, in the case of music, correspond to a genre characteristic of the music, such as, e.g., rock, jazz, classical, country, and the like.

The GUI also displays a second series of buttons, either on the same screen or a subsequent screen that is displayed after selection of a main category, corresponding to a plurality of subcategories for the media/data selections. For example, in the case of music, each subcategory may correspond to the speed of particular songs, such as, e.g., fast, medium or slow, as measured by their tempo or beats per minute, or a characteristic reflective of the energy or mood of the songs or their status as being among those designed by the user or service provider as his or her favorites.

The GUI also typically displays a third series of buttons, either on the same screen or a subsequent screen that is displayed after selection of the first subcategory, corresponding to a plurality of second subcategories for the media/data selections. Here again, in the case of music, the second subcategories may be the time periods over which the music selections are to be played.

Based on the user's specified main category/first subcategory/second subcategory selections, an illustrative system automatically retrieves the media/data selections fitting the specified categories and subcategories from the storage device and automatically generates a search list or playlist of the media/data selections meeting those criteria for immediate display and/or playback for the user's use and/or enjoyment.

As indicated in the '471 patent, the media/data selection system disclosed in the patent may be used in any of a variety of environments. It can, for example, be used in a business or home environment in which the GUI screens are displayed on a large screen television monitor (e.g., LCD, plasma, or the like), wireless, portable or wall mounted is video monitor or personal computer or laptop computer. Alternatively, as indicated in FIGS. 21 and 22 of the '471 patent, the system can be used in a mobile environment such as in an automobile, yacht or other such vehicle. With recent advances in the processing power of microprocessor-controlled hand-held devices, such as mobile or cell phones, PDAs and the like, it will be appreciated by those skilled in the art that the system of the '471 patent can also readily be implemented in such devices as well, provided that the devices have the necessary processing power, storage capabilities and user controllable interface.

Because of the media/data selection of the '471 patent can be adopted for use in any of a wide variety of host processors, it would be desirable if the system had the capability of automatically configuring its GUI to match the display screen size and interface capabilities of the host device in which it is used. It would also be desirable if the system were customizable and configurable under the control of the user to optimally match the particular preferences of the user and the particular characteristics of the host device in which the system is implemented.

Additionally, as noted above, many handheld devices currently available include the capability to play media selections. A noted disadvantage of such handheld devices is that there is a limited amount of the storage available on the handheld device for playback. Additionally, maintaining content on a handheld device and a separate media server complicates management of the user's digital content library. Thus, there is needed a system and method to provide better management of content and availability for handheld devices.

### SUMMARY OF THE INVENTION

The present invention overcomes the disadvantage of the prior art by providing a customizable, reconfigurable graphical user interface (GUI). An improved media/data selection system of the type disclosed in the '471 patent includes a GUI that can be customized and configured to suit any of a wide variety of user preferences and host device characteristics in accordance with an illustrative embodiment of the present invention.

The various GUI screens of the system may be automatically and dynamically (re)configured depending on the size of the display screen of the host device in which the system is implemented and/or the content available to the device from, e.g., local and/or remote data sources. Additionally, a plurality of user-selectable controls (buttons) and data-containing windows (lists) are provided in the GUI and, the user is enabled to change the characteristics of such buttons and lists in terms of their size, shape, location, color, style, line width, language, textual font and the like, to suit the user's particular desires and needs. A system in accordance with an illustrative embodiment of the present invention enables automatic and/or manual merging, updating, transferring and/or synchronization of GUI categories and subcategories and media/data selections from different databases and/or storage devices.

The present invention also provides improved media/data selection, search, and playback capabilities that can be specified via any language. These capabilities include a range and/or key word selection, search and playback facility that is adopted to locate media/data selections even if the key word(s) entered by the user for search purposes are misspelled or erroneously entered. The selection, search, and playback capability may or may not be visually available on the GUI.

The GUI also provides an improved media/data selection, search, and playback capabilities that can be specified via a variety of subcategories that are appropriate for each media/data type, such as (but not limited to) artist, title, year, album, moods, tempos, speeds, and the like for music and/or ratings, duration, producers, action, and the like for videos; and so on. The GUI further includes the functionality to provide an asynchronous media/data selection, search, and playback capability that displays in a GUI search window, substantially immediately, the initial results of a search request while additional searching proceeds asynchronously “behind the scenes” until the follow-on results of the search are available for display.

An illustrative embodiment of the present invention also provides the capability to monitor user activity through the system's GUI, collect and organize information/data regarding that activity and save the information/data for output utilization.

Furthermore, an illustrative embodiment of the present invention provides the capability to illustrate ancillary media/data visually (text or graphics), on top of the system's GUI and/or inside the play list wherein the source of the ancillary media/data selection being either internal or external to the system.

### BRIEF DESCRIPTION OF THE DRAWINGS

The above and further advantages of the invention may be better understood by referring to the following description in conjunction with the accompanying drawings in which like reference numerals indicate identical or functionally similar elements:

FIG. 1 is a schematic block diagram of an exemplary network environment containing devices that may utilize the teachings of the present invention in accordance with an illustrative embodiment of the present invention;

FIG. 2 is a schematic block diagram, substantially identical to the diagram of FIG. 29 of the '471 patent, illustrating a suitable hardware architecture of a media/data selection system embodied in accordance with an illustrative embodiment of the present invention;

FIG. 3 is a screen shot of a GUI screen for an embodiment of the invention suitable for display on a display screen monitor (i.e., LCD, plasma, etc.) of about 16 inches or greater in size on the diagonal such as might be used in a business or home implementation of the system in accordance with an illustrative embodiment of the of the present invention;

FIG. 4 is a screenshot of a GUI screen for display on a display screen monitor of about 9 inches to about 15 inches in size or the diagonal such as may be used in a business, home or laptop computer implementation of the system in accordance with an illustrative embodiment of the of the present invention;

FIGS. 5A-5D are screenshots of a GUI screen for display on a display screen monitor of about 6 inches to about 8 inches in size on the diagonal such as may be used in an automotive or other recreational vehicle, business or home installation of the system in accordance with an illustrative embodiment of the of the present invention;

FIGS. 6A-6E are screenshots of GUI screens for display on a display screen monitor of about 2 inches to about 5 inches in size on the diagonal such as may be used in a PMP (portable media player), PDA, GPS, mobile phone or other hand held device installation of the system in accordance with an illustrative embodiment of the of the pre-sent invention;

FIGS. 7A1-7E2 are plan views of a further alternative series of GUI screens for an embodiment of the invention suitable for display on a display screen monitor of about 1 inch to about 2 inches in size on the diagonal such as may be used in a mobile phone or user-wearable device (e.g., wrist player, micro chip, etc.) installation of the system in accordance with an illustrative embodiment of the of the present invention;

FIG. 8 is a flowchart illustrating the steps of a procedure for invoking auto configurations based on device type, display screen size, and user configurations based on device type or specific characteristics in accordance with an illustrative embodiment of the of the present invention;

FIG. 9 is a flowchart illustrating the steps of a procedure for enabling user changes to the characteristics of GUI buttons and displayed lists in accordance with an illustrative embodiment of the of the present invention;

FIGS. 10A-10C are screenshots GUI screens generated by a user “grabbing” the corner border of the GUI and “dragging” it to increase the size of the display in accordance with an illustrative embodiment of the of the present invention;

FIG. 11 is a flowchart detailing the steps of a procedure for improvements related to the user's experience of selection, search, and playback, including language improvements, partial key word searching, misspelling tolerance, and key word range features in accordance with an illustrative embodiment of the of the present invention;

FIG. 12 is a flowchart detailing the steps of a procedure for improvements related to the user's experience of selection, search, and playback in regard to specifying sub-category selection as applied to each media/data type in accordance with an illustrative embodiment of the of the present invention;

FIGS. 13A-13B are flowcharts detailing the steps of a procedure for an improved process for asynchronous database search and retrieval that creates the performance improvement observed by the user as substantial immediacy in accordance with an illustrative embodiment of the present invention;

FIG. 14 is a flowchart detailing the steps of a procedure for an improved process for merging and/or synchronizing GUI buttons and/or media/data databases among two or more systems in accordance with an illustrative embodiment of the of the present invention;

FIG. 15 is a flowchart detailing the steps of a procedure for an improved process for user activity monitoring; and

FIG. 16 is a flowchart detailing the steps of a procedure for an improved process for displaying ancillary media/data visually (text and/or graphics) on top of the system GUI in accordance with an illustrative embodiment of the of the present invention;

FIG. 17 is a screenshot of an exemplary graphical user interface screen illustrating the overlaying of ancillary data in accordance with an illustrative embodiment of the pre-sent invention;

FIG. 18 is a schematic block diagram of an exemplary network environment including a handheld device in accordance with an illustrative embodiment of the present invention;

FIG. 19 is a flowchart detailing the steps of a procedure for modifying the source of media on a handheld device in accordance with an illustrative embodiment of the pre-sent invention;

FIGS. 20A-20E are screenshots of a GUI for selection of media source in accordance with an illustrative embodiment of the present invention;

FIG. 21 is a flowchart detailing the steps of a procedure for modifying the displayed set of category buttons in accordance with an illustrative embodiment of the pre-sent invention;

FIG. 22A-22B are screenshots of a GUI screen illustrating the modification of categories to be displayed in accordance with an illustrative embodiment of the present invention;

FIG. 23 is a flowchart detailing the steps of a procedure for modifying the sub-category buttons to be displayed in accordance with an illustrative embodiment of the present invention;

FIGS. 24A-24D are screenshots of a GUI for modifying the subcategory buttons displayed in accordance with an illustrative embodiment of the present invention;

FIG. 25 is a flow chart detailing the steps of a procedure for automatic generation of a playlist based on selecting a category in accordance with an illustrative embodiment of the present invention;

FIGS. 26A-26B are screenshots of a GUI illustrating the automatic generation and playing of the playlist by selecting a category button in accordance with an illustrative embodiment of the present invention;

FIG. 27 is a flowchart detailing the steps of a procedure for automatic generation of a playlist by selecting a subcategory in category buttons in accordance with an illustrative embodiment of the present invention; and

FIGS. 28A-28C are screenshots of a GUI illustrating the automatic generation of a playlist based on selection category and subcategory buttons in accordance with an illustrative embodiment of the present invention.

### DETAILED DESCRIPTION OF AN ILLUSTRATIVE EMBODIMENT

### A. Environment and System

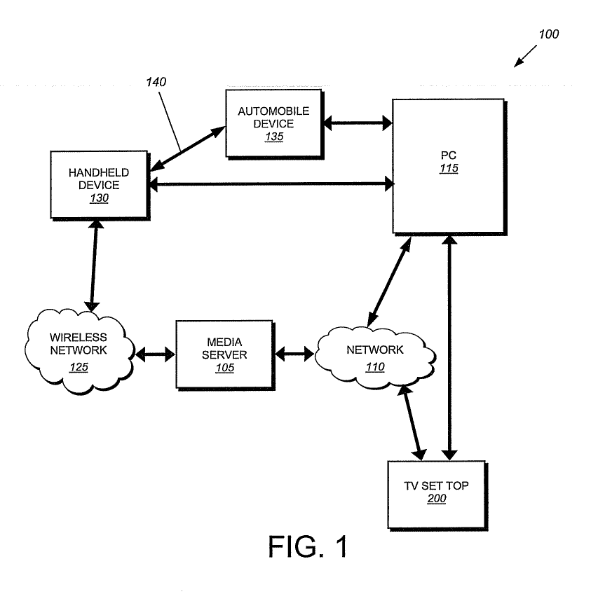

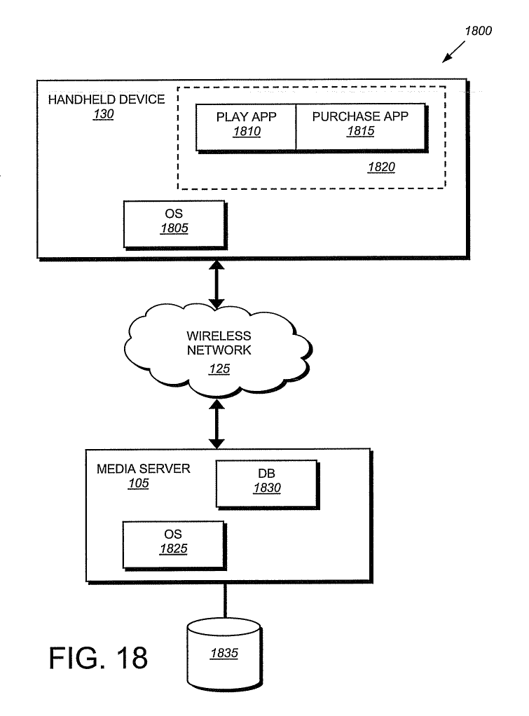

FIG. 1 is an exemplary environment 100 showing potential devices that may utilize the teachings of the present invention in accordance with an illustrative embodiment of the present invention. Environment 100 illustratively includes a media server 105 that acts as a content provider for other devices within environment 100. The media server 105 may comprise a dedicated computer and/or general-purpose computer running specialized software. Media server 105 is described further below in reference to FIG. 18. Operatively interconnected with the media server 105 is a network 110 that may comprise a conventional wide area network (WAN), local area network (LAN), virtual private network (VPN), etc. In an illustrative embodiment, the network 110 may comprise the well-known Internet.

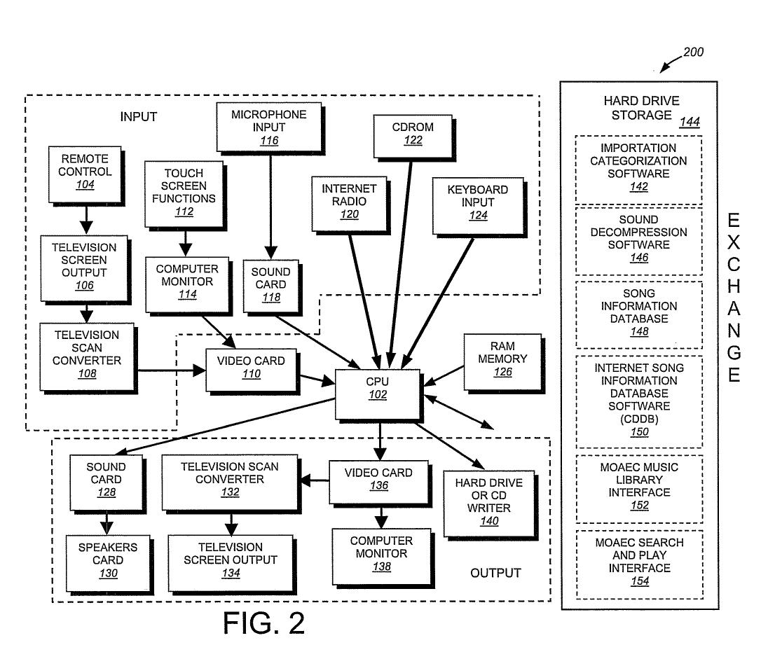

Interconnected with the network 110 is a personal computer 115 that may execute software (not shown) for playing media from the media server 105. Also interconnected with the network 110 is a TV set top 200, described further below in referenced in FIG. 2. A wireless network 125 may also be operatively interconnected with the media server 105. The wireless network 125 may comprise a conventional WiFi network, a Bluetooth network, etc. Alternatively, the wireless network may be embodied as a cellular based network, such as the well known EDGE network and/or conventional 3G wireless networks available via cellular telephones and other handheld devices.

A handheld device 130 may be illustratively connected with the wireless network in accordance with an illustrative embodiment of the present invention. The handheld device 130 may comprise a cellular telephone, a personal digital assistant, etc. The handheld device may be interconnected via interconnect 140 to an automobile device 135. The automobile device 135 may be integrated with an automobile to enable content temporarily stored on a handheld device to be played via the audio system within an automobile. Interconnect 140 may comprise, for example, a Bluetooth connection, a wired connection between handheld device and the automobile, etc. It should be noted that the automobile device 135 may be integrated with any vehicle, e.g., boat, plane, etc. As such, the description of an automobile should be taken as exemplary only.

In alternative embodiments of the present invention, the PC 115 may be operatively interconnected with the TV set top 200, an automobile device 135 and/or a handheld device 130 without going through an intermediate network. In such embodiments, the PC 115 may be directly connected with, e.g., a handheld device 130 via, for example, a docking cradle connected to a USB cable.

FIG. 2 is a schematic block diagram substantially identical to the diagram in FIG. 29 of the '471 patent, illustrating a suitable hardware architecture of the media/data selection system embodied in accordance with an illustrative embodiment of the present invention. Illustratively, the architecture may be implemented in a TV set top 200; however, it should be understood that in alternative embodiments additional and/or other embodiments may be utilized. System 200 includes a plurality of inputs including, for example, a remote control 104, a touch screen 112, a microphone 116, Internet radio 120, CD/DVD-ROM 122, keyboard input 124. It should be noted that in alternative embodiments additional and/or differing inputs may be utilized.

The remote-control 104 provides input to a television screen 106, which feeds into a television scan converter 108 before being fed into a video card 110. The video card output is then passed to a central processing unit (CPU) 102. It should be noted that in alternative embodiments of the present invention, a plurality of processors may be utilized. As such, the description of a single processor system should be taken as exemplary only. Similarly, touchscreen functionality may be applied to a computer monitor 114 with suitable output provided to the video card 110. A microphone input 116 may be fed into a sound card 118 for processing before being passed to the processor 102. Operatively interconnected with the processor 102 is memory 126.

Furthermore, the system 200 may include a plurality of outputs including, for example, a soundcard 128, a video card 136, a hard drive or other storage mechanism 140. It should be noted that in certain illustrative embodiment soundcards 118 and 128 and may comprise the same physical soundcard. However, in alternative embodiments, a plurality of soundcards utilized. Similarly, video cards 110 and 136 may comprise the same physical video card or may comprise a plurality of video cards. The soundcards output 128 may be through a set of speakers 130. The speakers may be integrated with the system 200 or may be externally connected using conventional speaker connection systems.

The CPU 102 illustratively executes a number of software modules including, for example, an importation categorization software module 142, sound decompression software 146, song information database 148, Internet song information database (e.g., CDDB) 150, MOAEC music library interface 152 and a MOAEC search and play interface 154. It should be noted that in alternative embodiments of the present invention, the functionality of each of these modules may be combined and/or split. As such, the description of the specific modules contained herein should be taken as exemplary only.

### B. Dynamic GUI

The present invention provides a system and method for a dynamic customizable graphical user interface. In accordance with an illustrative embodiment of the present invention, the system will determine the display type and characteristics and dynamically reconfigure the GUI to be compatible with the output device associated therewith. For example, buttons and/or other GUI elements may be modified, displayed in different orientations, organized into different menu structures, and/or other variations based on the size of and/or capabilities of the display device. By maintaining the dynamic configurable GUI, a common look and feel may be applied across a platform for use with a multimedia organizer and playback device regardless of the intended output device, whether it is a large scale television in a home, a handheld device, a personal computer, etc.

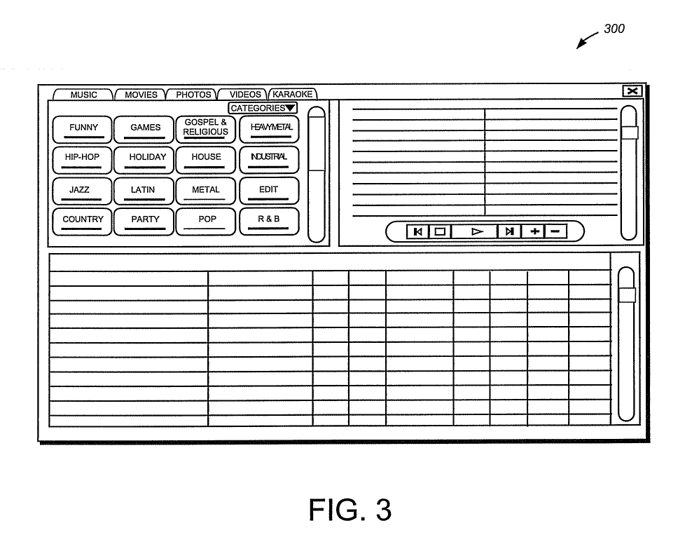

FIGS. 3-7 are exemplary screenshots of a dynamic, reconfigurable GUI in accordance with an illustrative embodiment of the present invention. While, this description is written in terms of a GUI for a media playback system, the principles of the present invention may be applied to any GUI. As such, the description of a media playback GUI should be taken as exemplary only.

FIG. 3 is a screenshot of a graphical user interface (GUI) screen 300 for display on a display screen monitor of approximately 16 inches or greater in size on the diagonal such as might be used in business or home implementation in accordance with an illustrative embodiment of the present invention.

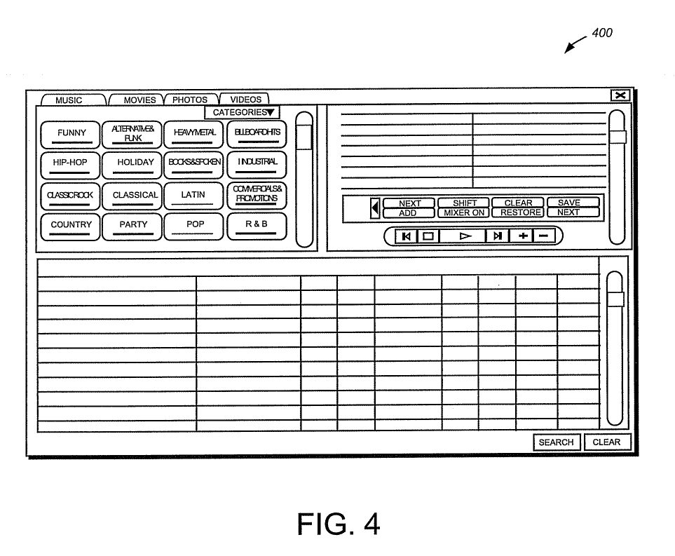

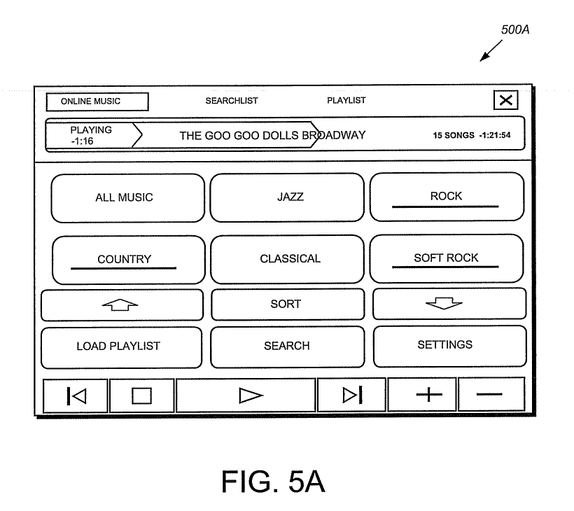

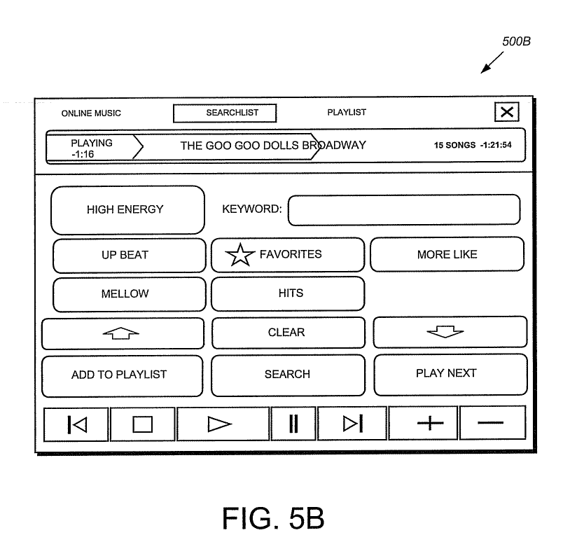

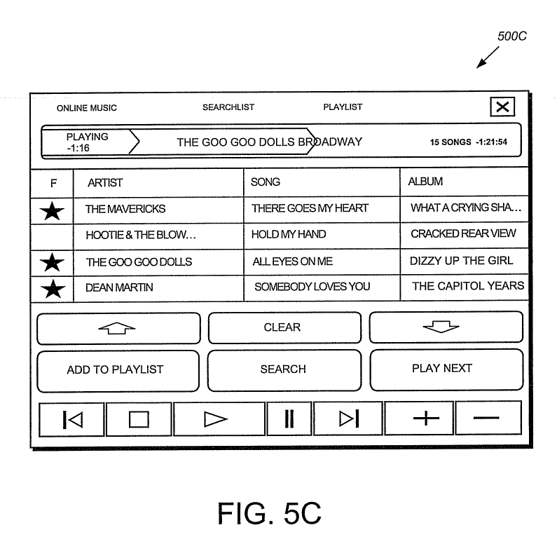

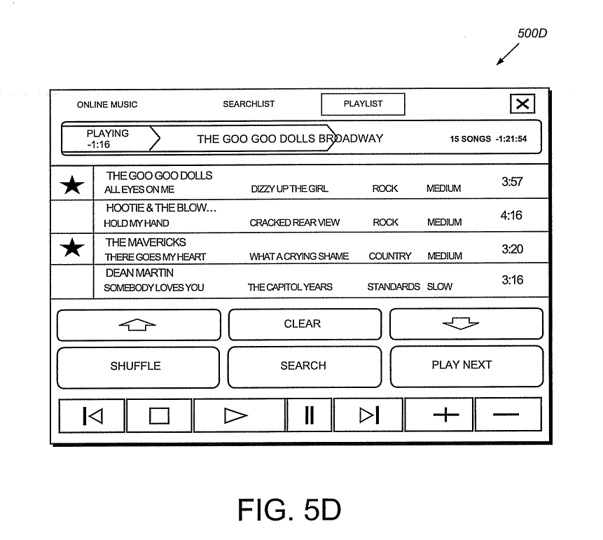

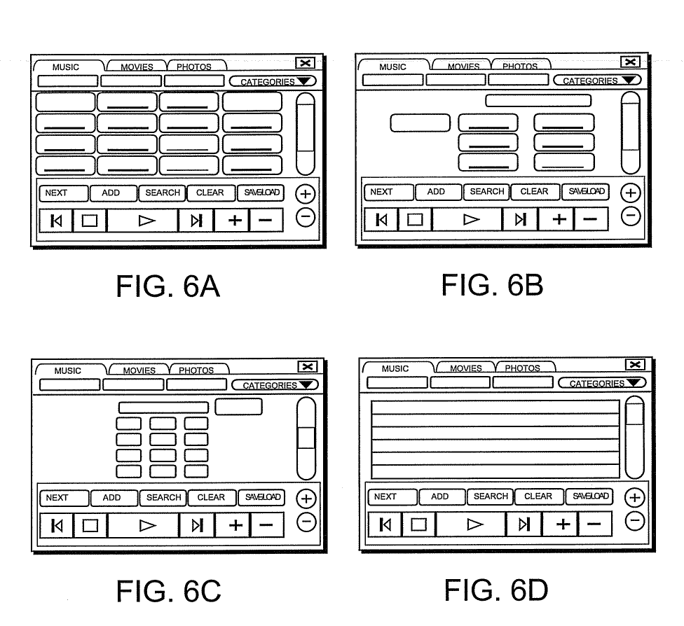

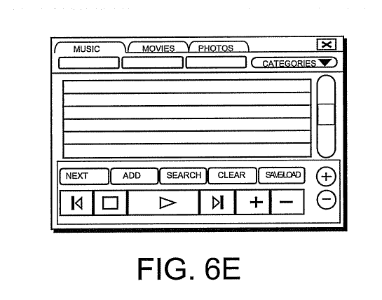

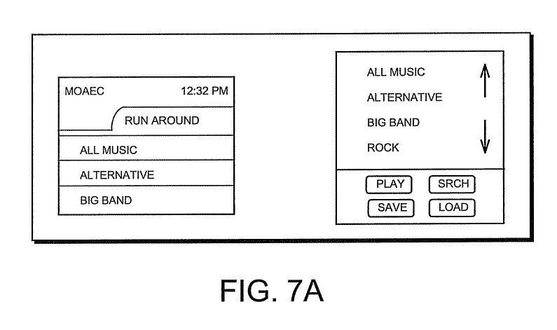

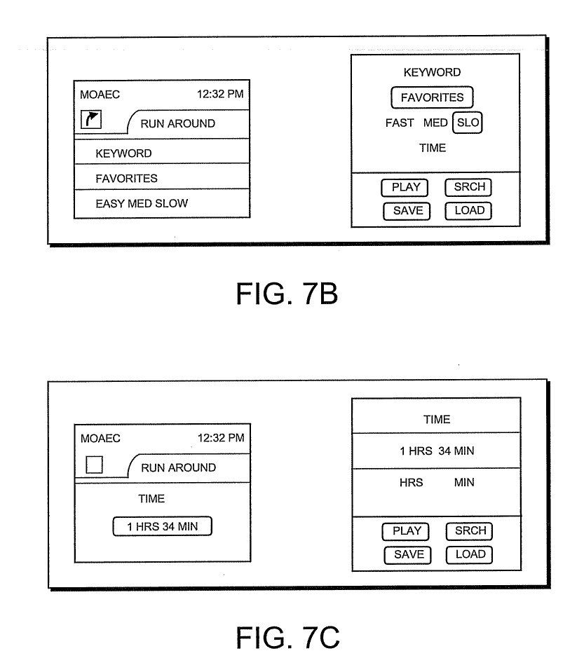

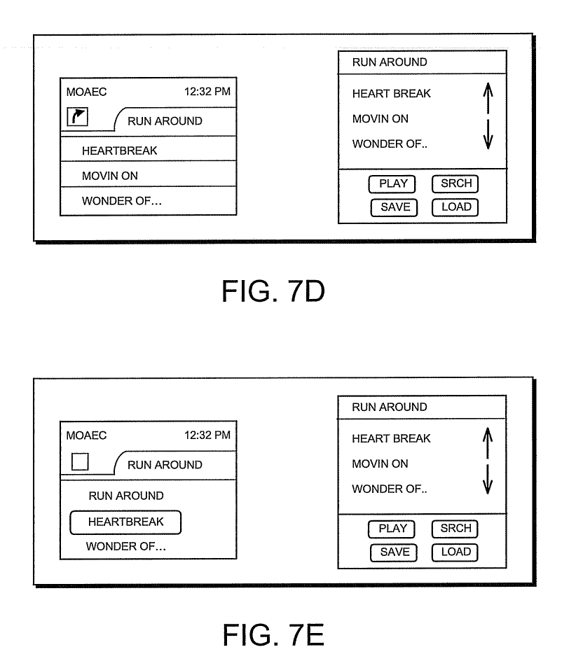

FIG. 4 is a screenshot of a GUI screen 400 for display and editing on a display screen monitor of approximately 9 inches to approximately 15 inches in size on the diagonal such as may be used in a business, home or laptop computer implementation of the present invention. FIGS. 5A-5D are screenshots of a GUI screen 500 for display on a display screen monitor of approximately 6 inches to approximately 8 inches in size of the diagonal such as may be used in automotive or other recreational vehicle, business or home installation. FIGS. 6A-6E are screenshots of GUI screens for display on a display screen monitor of approximately 2 inches to approximately 5 inches in size of the diagonal such as may be used in a portable media player, PDA, GPS, mobile phone or other handheld device. Similarly, FIGS. 7A1-7E2 are screenshots of a GUI that may be suitable for displaying a display screen monitor of approximately 1 inch to approximately 2 inches in size on the diagonal such as may be used in a mobile phone or in accordance with an illustrative embodiment of the present invention.

### C. Autoconfiguration of GUI

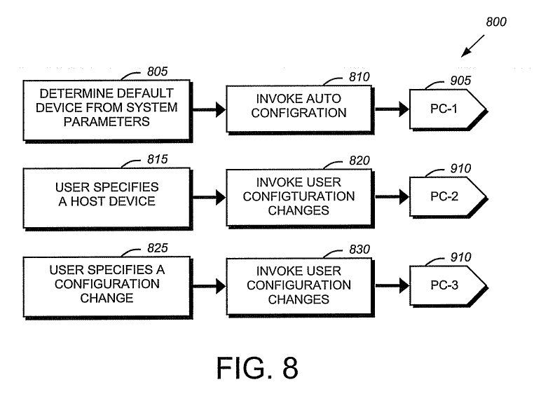

FIG. 8 is a flowchart detailing the steps of a procedure 800 for invoking auto configuration based and device type, display screen size and/or user configurations based on device type or specific characteristics in accordance with an illustrative embodiment of the present invention. The procedure 800 begins in step 805 where the system determines the default device from system parameters before invoking auto configuration in step 810. Illustratively, this may be performed by querying the operating system executing on the device through which the configuration is desired. For example, in a conventional Windows based operating system, the operating system exposes a set of application program interfaces (APIs) that may be used to query the system to determine the size of the display device connected thereto. Based on that response, the appropriate auto configuration may be performed. Similarly, a user may specify a host device in step 815 which then invokes the appropriate user configuration changes in step 820. Finally, a user may specify configuration change which then invokes user configuration changes in step 830. It should be noted that the description herein of a Windows based GUI should be taken as exemplary only and that the principles of the present invention may be applied to any GUI operating on a system in which the characteristics of the display device may be obtained by the GUI to enable auto configuration of the display. In an alternative embodiment, the user may provide the display characteristics to the system if the system in incapable to automatically providing the characteristics to the GUI via, e.g., APIs, etc.

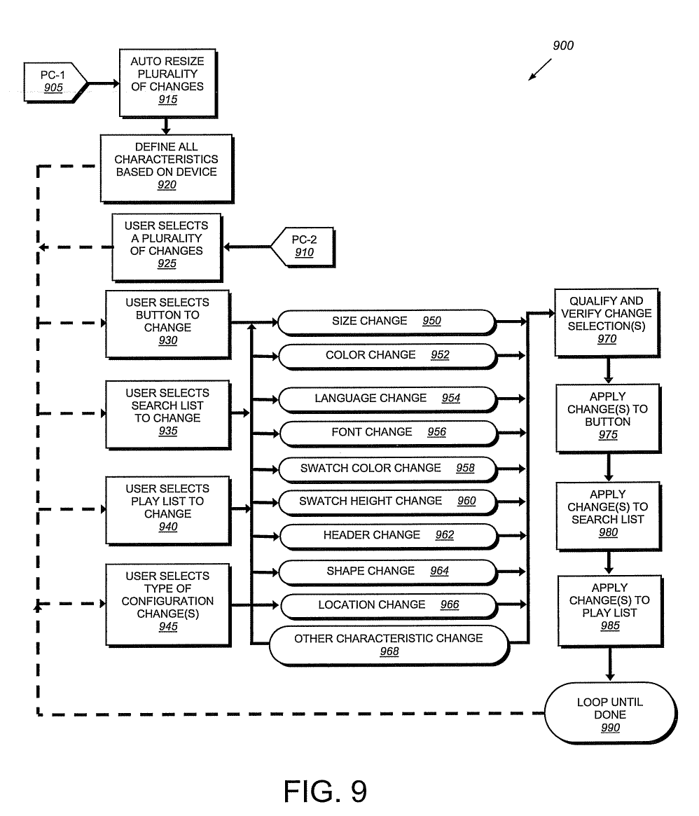

FIG. 9 is a flowchart detailing the steps of a procedure 900 for enabling user changes to a graphical user interface buttons and displayed items in accordance with an illustrative embodiment of the present invention. The procedure 900 may begin at step 905 as a result of the auto configuration from step 810 of procedure 800. In such cases, the procedure 900 moves to step 915 where a plurality of changes occurs based on the detected display device. The procedure 900 then continues to step 920 where are all characteristics based on the device are defined. In an alternative embodiment, the procedure 900 may be entered from step 910. This may occur when, for example, a user specifies a host device or a configuration change in procedure 800. In such embodiments the procedure moves from step 910 to step 925 were the user selects a plurality of changes to occur.

The procedure 900 then moves to one of steps 930, 935, 940 or 945. For example, a user may select a button to change in step 930, a user may select a search list to change in step 935, a play list to change in step 940 or a type of configuration changes in step 945. The procedure may then branch to a number of differing change steps depending on the selected changes. For example, a size change 950, a color change 952, a language change 954, a font change 956, a swatch color change 958, a swatch height change 960, a header change 962, a shape change 964, a location change 966 and/or other characteristic changes 968.

Once the various changes have been made, the procedure then qualifies and verifies the changed selections in step 970. The changes are then applied to the appropriate button in step 975, the search list in step 980 and the playlist in step 985. The procedure 900 then loops until the procedure completes in step 990. It should be noted that procedure 900 has been described in terms of changes; however, the principles apply to a singular change. As such, the plural should be taken to include the singular, and vice versa, with respect to the number of changes being made to the configuration.

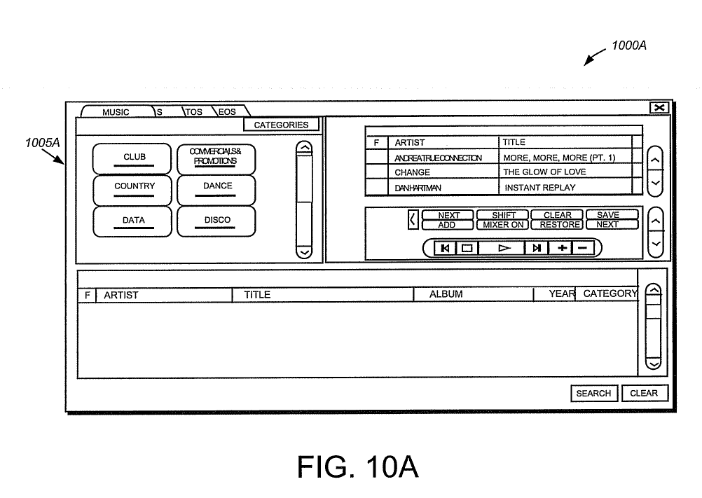

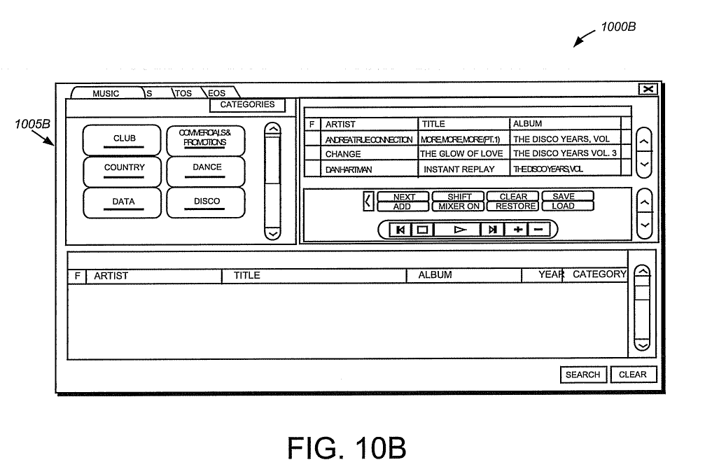

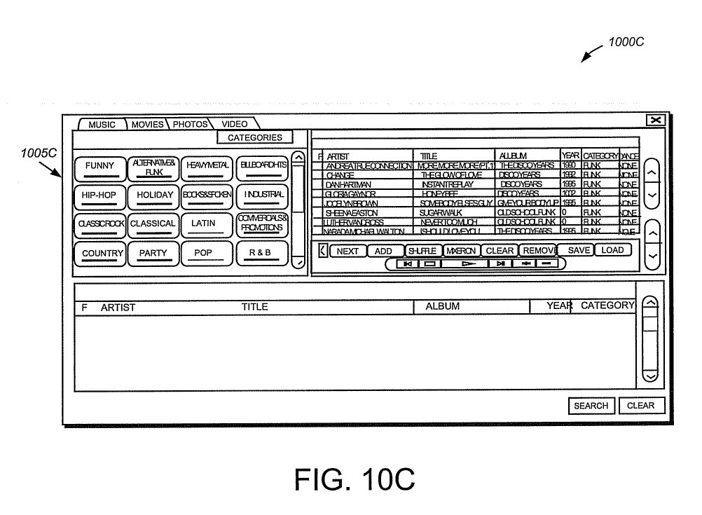

FIG. 10A is a screenshot of an exemplary GUI 1000A in accordance with an illustrative embodiment of the present invention. FIGS. 10B-10C illustrate a sequence of dynamic adjustment of the display of the GUI screen 1000A in response to a user clicking and dragging or otherwise causing the screen to enlarge. As can be seen, as the screen size increases, the number and types of buttons and elements in the scroll list increase to take advantage of the additional GUI screen space available. For example, in screen 1000A, there is a collection of category buttons 1005A of which six are displayed on screen. As the screen is enlarged to screen 1000B, the collection of buttons 1005B grows to display nine buttons. Finally, as the screen is expanded to screen 1000C, the collection of buttons 1005C grows to display 20 buttons. It should be noted that alternative techniques may be used to modify a GUI screen, e.g., minimizing, maximizing, etc. As such, the description of clicking and dragging a screen should be taken as exemplary only. Furthermore, in alternative embodiments of the present invention, sizes of buttons may grow in addition to and/or in place of the increase of the number of buttons displayed. As such, the description above should be taken as exemplary only.

### D. Asynchronous Search and Playback

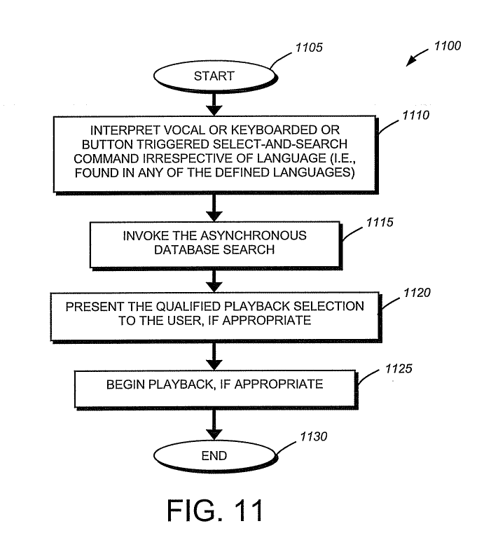

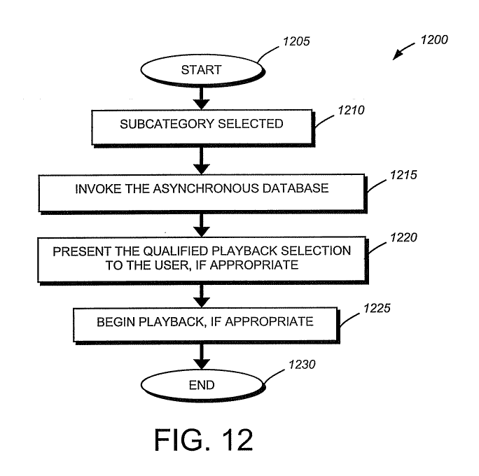

FIGS. 11-12 are flowcharts detailing steps of procedures for selection, search and playback based on category and/or subcategory selection. These procedures illustratively generate a playlist that can then be played. In alternative embodiments, the user can save one or more generated playlists. These saved playlists may include content that is local to a device and/or that is streaming from a remote source, e.g., a media server. Furthermore, the playlists can be merged among all devices, e.g., phones, PDAs, automobiles, homes, set top boxes, etc.

FIG. 11 is a flowchart detailing the steps of a procedure 1100 for selection, search and playback in accordance with an illustrative embodiment of the present invention. The procedure 1000 begins in step 1105 and continues to step 1110 where the system interprets a vocal, keyboard or other input operation. For example a user may vocalize the title of a song using any audio input device, may select by clicking on a button, or may began typing a title or artist using a keyboard, etc. In response, an asynchronous database search is invoked in step 1115. The procedure 1100 then presents a list of qualified playback selections to the user (where appropriate) in step 1120. Then, if appropriate, the playback of the selected media is begun in step 1125. The procedure 1100 ends in step 1130.

FIG. 12 is a flowchart detailing the steps of a procedure 1200 for improved playback, selection and/or search when utilizing a subcategory in accordance with an illustrative embodiment of the present invention. The procedure 1200 begins in step 1205 and continues to 1210 where one or more subcategories are selected. An asynchronous database search is invoked in step 1215. If appropriate, qualified playback selections are presented to the user in step 1220. Playback is begun, if appropriate, in step 1225. The procedure 1200 then completes in step 1230. It should be noted that in accordance with alternative embodiments of the present invention, a plurality of levels of subcategories may be utilized. As such, the description of a single level of subcategories should be taken as exemplary only. Similarly, in an alternative embodiment of the present invention, a sub-genre may be utilized as one level of subcategories.

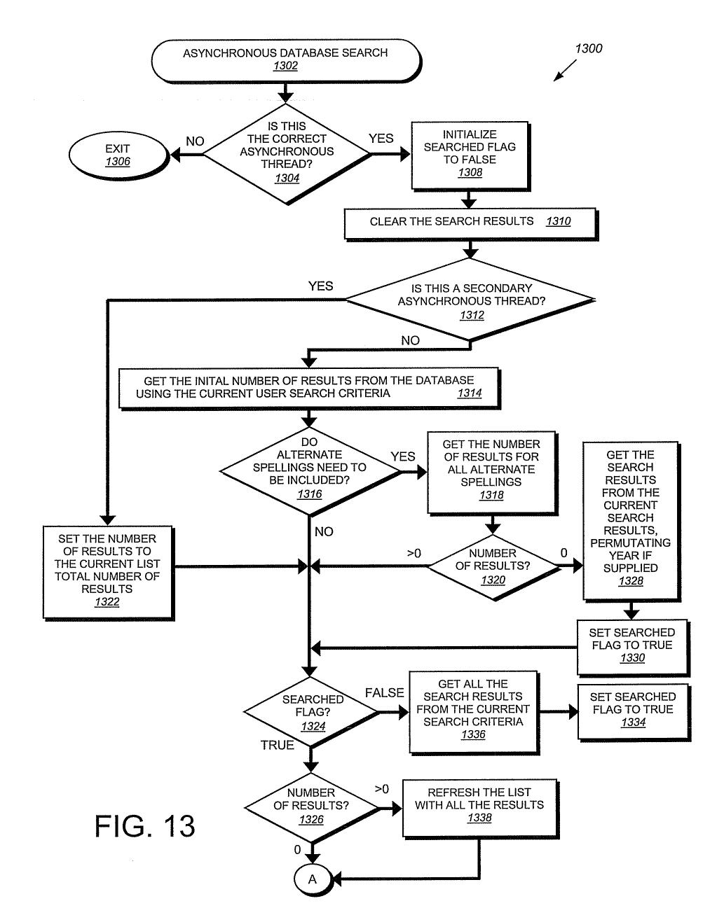

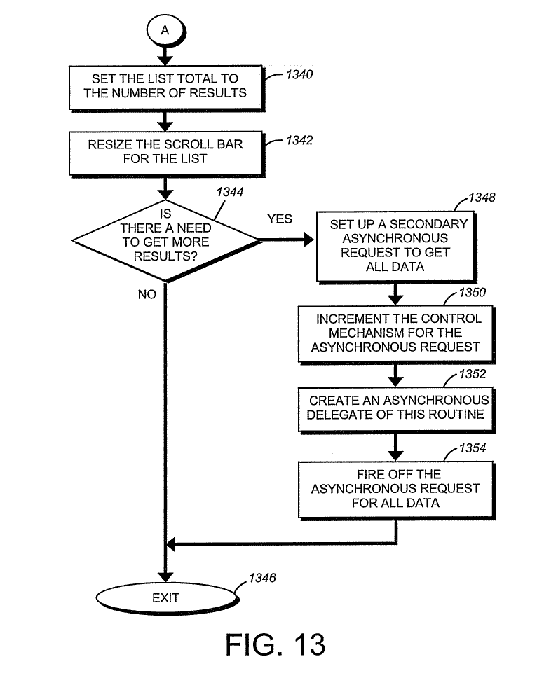

FIG. 13 is a flowchart detailing the steps of a procedure 1300 for performing an asynchronous database search and retrieval in accordance with an illustrative embodiment of the present invention. In accordance with illustrative embodiments of the present invention, the asynchronous database search may utilize locale, remote and/or a combination of local and remote databases when performing a search. As such, the present invention should be read to encompass embodiments where one or more locale databases, one or more remote databases or a combination of one or more local and remote databases are utilized. The procedure 1300 begins in step 1302 where an asynchronous database search is initiated. This search may be initiated due to, e.g., procedures 1100 or 1200 as described above.

Illustratively, each asynchronous database search is performed by a separate thread within the device. However, in alternative embodiments, the asynchronous searching may be performed within a single thread or by using differing processes, etc. As such, the description of a multi-threaded approach should be taken as exemplary only. A determination is made in step 1304 whether this is the correct asynchronous thread for a database search. If not, the procedure branches to step 1306 and completes. However, if the correct asynchronous thread is identified in step 1304, then the procedure branches in step 1308 where the search flag is initialized to a false value. Then, in step 1310, the search results are cleared. A determination is made in step 1312 whether this is a secondary asynchronous request. If so, then the procedure branches to step 1322 through the number of results is set to the current list total number of results. However, if in step 1312 it is determined that this is not a secondary asynchronous request, then the procedure continues to step 1314 where the initial number of results from the database is obtained using the current user search criteria. A determination has been made in step 1316 whether alternate spellings need to be included. If they do, then the procedure branches to step 1318 and the number of results for all alternate spellings is obtained a before the procedure branches to step 1320 where a determination is made whether the number of results equal zero or a value greater than zero.

If the number of results equal zero then the procedure branches to step 1328 with the search results in the current search results are obtained. The search flag is then set to true in step 1330. The procedure then branches to step 1324 where a determination is made whether the search flag is set to true or false. If it is set to false, then the procedure branches in step 1336 were all search results in the current search criteria are obtained before the search flag is set to true in step 1334. If the search flag is deemed to be true the procedure continues to step 1326 work again a determination is made as to the number of results. If the number of results is greater than zero, then the procedure refreshes the list of all the results in step 1338. The list total is set to the number of results in step 1340. The scrollbar is resized for the appropriate members of the list in step 1342. A determination is made in step 1344 whether there is a need to obtain additional results. If not, the procedure then exits in step 1346. However if there is a need to obtain more results the procedure branches to step 1348 where a secondary asynchronous request is initiated to obtain all of the data path. Then in step 1350 the control mechanism is incremented for the asynchronous request an asynchronous delegate of the routine is created in step 1352. Finally, in step 1354 the asynchronous request for all the data is sent before the procedure 1300 or exits in step 1346.

It should be noted that in an alternative embodiment, a plurality of threads may be launched to perform a plurality of asynchronous searches in parallel with the results merges prior to display to the user. This may occur when, e.g., a user desires to search both the local device and one or more remote media sources. This may be utilized to eliminate the on device/off device distinctions and to provide for seamless integration between media stored locally and remotely.

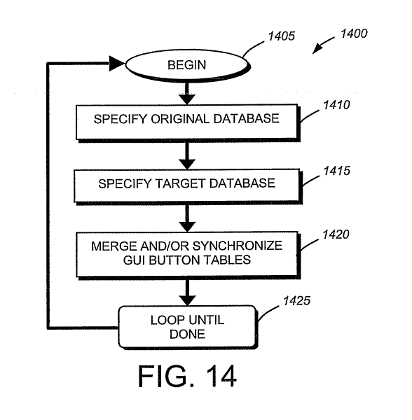

FIG. 14 is a flowchart detailing the steps of a procedure 1400 for merging and/or synchronizing one or more GUI buttons and/or media/data databases between two or more systems in accordance with an illustrative embodiment of the present invention. The procedure 1400 begins in step 1405 and continues to step 1410 where the original database is specified. Then, in step 1415 the target database is specified. At step 1420 GUI button tables are then merged and/or synchronized. This may occur by, e.g., the use of conventional SQL functions or may occur by exporting data using XML. The procedure 1400 then loops (step 1425) until the process is completed.

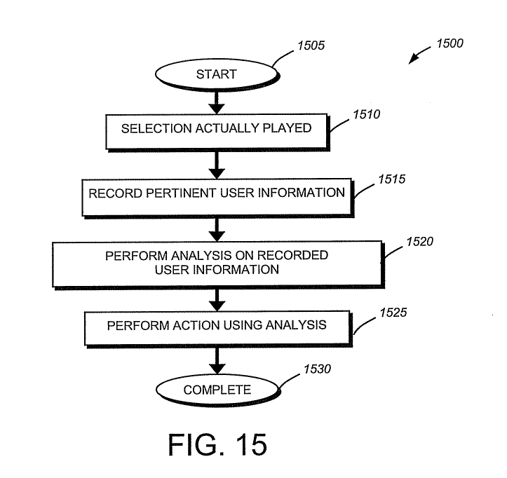

FIG. 15 is a flowchart detailing the steps of a procedure 1500 for user activity monitoring in accordance with an illustrative embodiment of the present invention. The procedure 1500 begins in step 1505 before transitioning to step 1510 where a user's media selection is played. Once this selection has been played, pertinent user information is recorded in step 1515. The user information may comprise, e.g., category and/or subcategory information, a timestamp, user identification, length of selection, how much of the content was viewed/listened to, etc. The system may then perform one or more analyses on the recorded user information in step 1520. These analyses may comprise, e.g., determining the most frequently selected categories, subcategories, etc., identifying most frequently played songs, etc. The analysis may be conducted on a per user basis or on a meta-basis that included data on a plurality of users. For example, a content provider of streaming media may perform meta-analysis to identify the most popular songs among all of its users (or a subset thereof). The system then performs some user action based on the analysis in step 1525. The action may vary depending on system configuration. For example, the GUI may dynamically reconfigure based on the analysis by, e.g., placing categories and/or subcategories that are more popular higher on a list. Alternatively, the information may be used for licensing and/or pricing purposes. Furthermore, the results of the analysis may be used to ensure parental controls, etc. is being properly implemented. The procedure 1500 then completes in step 1530.

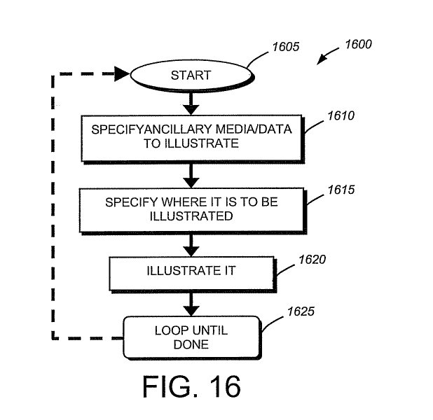

FIG. 16 is a flowchart detailing the steps of a procedure 1600 for displaying ancillary media/data visually on top of the system GUI in accordance with an illustrative embodiment of the present invention. The procedure 1600 begins in step 1605 and continues to step 1610 where the ancillary media/data is specified. Then, in step 1615, it is specified where the ancillary media/data is to be illustrated. The ancillary data is then illustrated in step 1620. The ancillary media/data may illustratively comprise advertisements such as, e.g., audio, text and/or graphical ads, banner ads, search based ads and/or sponsored ads. The content may be provided, but is not limited to local storage and/or network and/or the remote media server and/or the remote content providers. In an alter native embodiment, a handheld device determines its location using, e.g., GPS, etc. and dynamically adjusts advertisements to be displayed based on the location of the handheld device. The procedure 1600 loops (step 165) until the procedure is done.

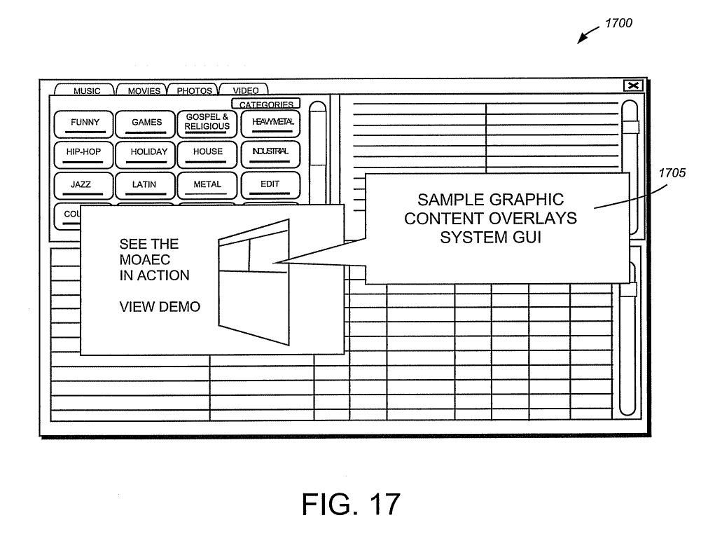

FIG. 17 is an exemplary screenshot of a GUI screen 1700 illustrating the display of ancillary data in accordance with an illustrative embodiment of the present invention. Ancillary data 1705 is displayed overlaid onto the GUI screen 1700.

### E. Handheld Devices

FIG. 18 is a schematic block diagram of an exemplary handheld device environment 1800 in accordance with an illustrative embodiment of the present invention. The handheld device environment 1800 is centered on a wireless network 125. As noted above, the wireless network 125 may comprise a conventional WiFi network, a Bluetooth network, or cellular based network such as the EDGE and/or 3G. networks. However, it should be noted that these are exemplary only and that any form of wireless network communication may be utilized in accordance with alternative embodiments of the pre-sent invention.

The media server 105 includes an operating system 1825, which may be, for example a Microsoft Windows-based operating system, Linux, Mac OS, etc. Additionally executing a media server 105 is a database application 1830 that is utilized in the distribution and management of digital media. In an illustrative embodiment of the present invention the database application may comprise a SQL server. However, in alternative embodiments of the present invention additional and/or differing database implementations may be utilized. As such, the description of a SQL server should be taken as exemplary only. Also operatively interconnected with the media server 105 is a set of mass data storage 1835. Illustratively the mass data storage devices 1835 comprises one or more hard disks. However, in alternative embodiments master the storage may comprise any form of storage including, for example, tapes, DVD, CD, flash and/or other forms of persistent electronic, electromagnetic, or optical media.

The handheld device 130, which may comprise a cellular telephone, a personal digital assistant, or other content playing device illustratively includes an operating system 1805. Executing on top of the operating system 1805 is a playing application 1810 that is utilized for content playback. Additionally, purchasing application 1815 may execute to connect to a content source, which may be the media server 105, to purchase new and/or additional digital content. In an illustrative embodiment of the present invention the playing and purchasing applications 1810, 1815 may be combined into a single application 1820.

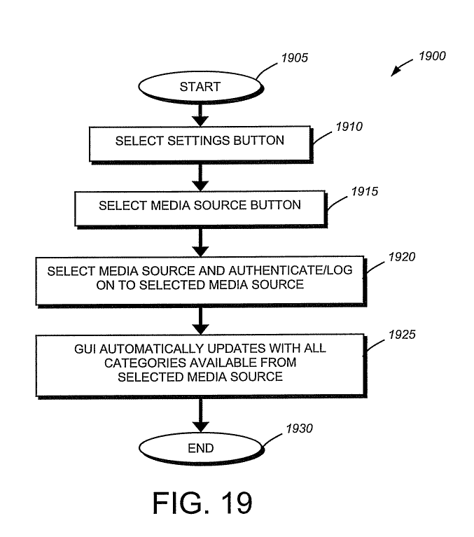

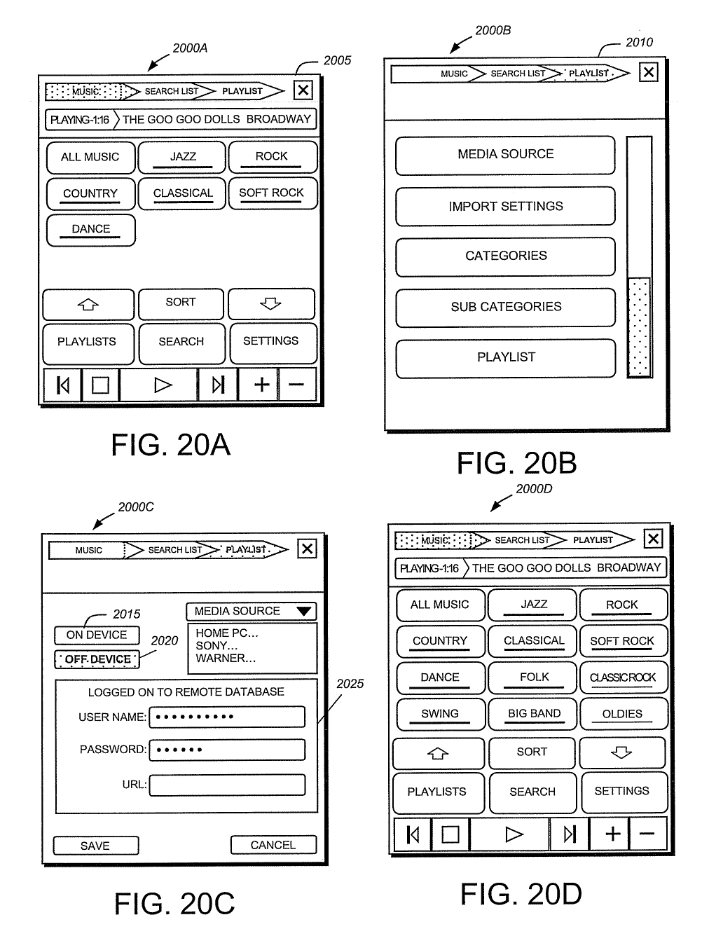

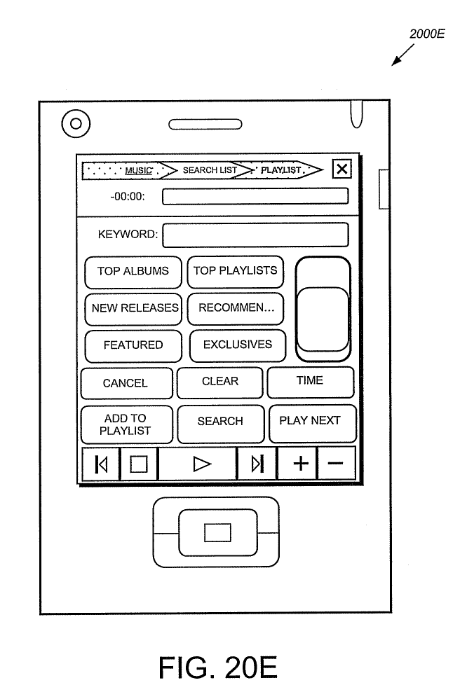

FIG. 19 is a flowchart detailing the steps of a procedure 1900 for modifying the source of media content in accordance with an illustrative embodiment of the present invention. The procedure 1900 begins in step 1905 and continues to step 1910 where a user selects a settings button. An exemplary graphical user interface screen 2000A is shown in FIG. 20A including an exemplary settings button 2005. In response to the settings button being activated, a new menu may be displayed such as that shown in GUI window 2000B in FIG. 20B. The user then, in step 1915 selects a media source button 2010, which causes the handheld device to display an exemplary screen, such as GUI window 2000C (FIG. 20C). The user may then select media source and authenticate/logon to a selected media source. Illustratively this may comprise selecting an off device button 2020, as opposed to an on device button 2015. Appropriate fields 2025 for user name password and/or uniform resource locator are provided in accordance with an illustrative embodiment of the present invention. In response to logging onto a new media source, the GUI automatically updates all categories available from the selected media source. This is illustratively illustrated in FIG. 20B. As can be seen additional and/or differing categories are shown in GUI window 2000D as compared to the original GUI window 2000A. Furthermore, in an alternative embodiment of the present invention, the GUI screen 2000E may be displayed (FIG. 20E) illustrating additional categories and/or subcategories that are available from an online source.

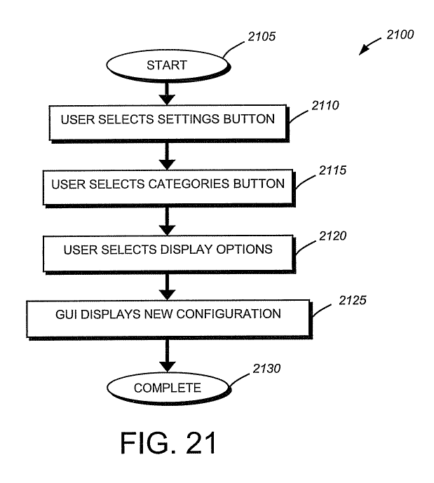

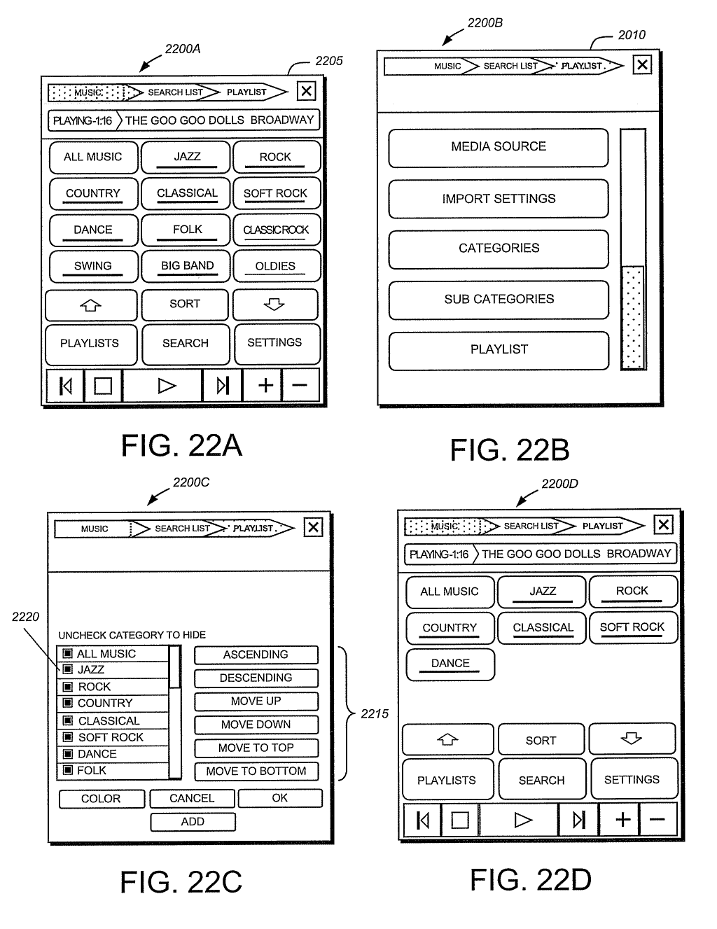

FIG. 21 is a flowchart detailing the steps of a procedure 2100 for using the graphical user interface to select desired category buttons to be displayed in accordance with an illustrative embodiment of the present invention. The procedure 2100 begins in step 2105 and continues to step 2110 where a user selects a settings button 2205 as illustrated in FIG. 22A. In response to user selecting the settings button, a settings menu 2200B is displayed as shown in FIG. 22B a user then selects a categories button 2210. In response, the GUI displays a menu 2200C which includes a list of categories 2220 as well as a selection of buttons 2154 for enabling updating and/or sorting the list of categories. Once a user has selected and made any display options, the GUI then displays new configuration in step 2125. An exemplary revised GUI window 2200D is shown in FIG. 22D. The procedure 2100 then completes in step 2130.

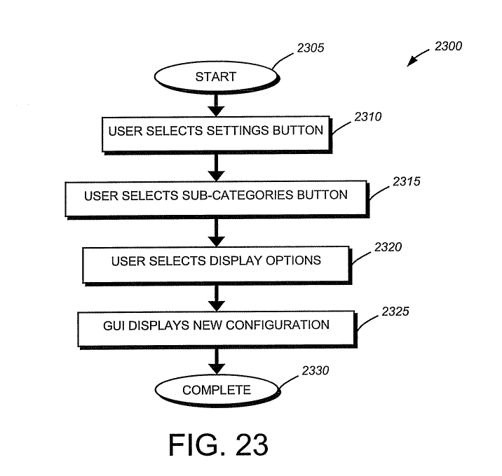

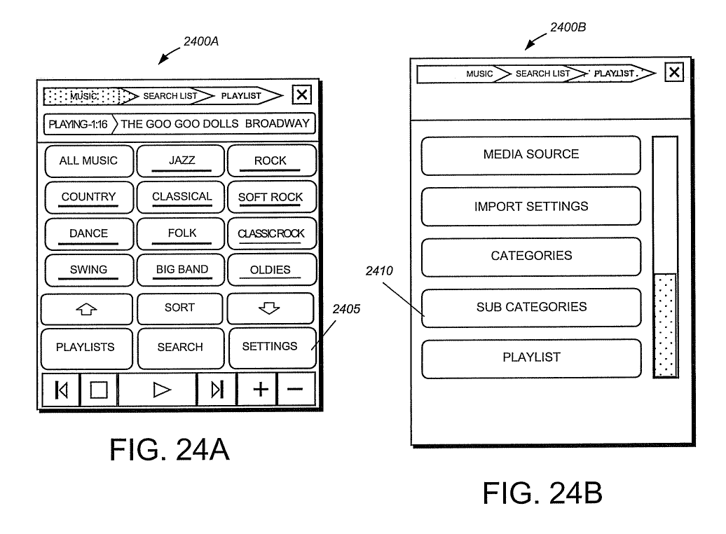

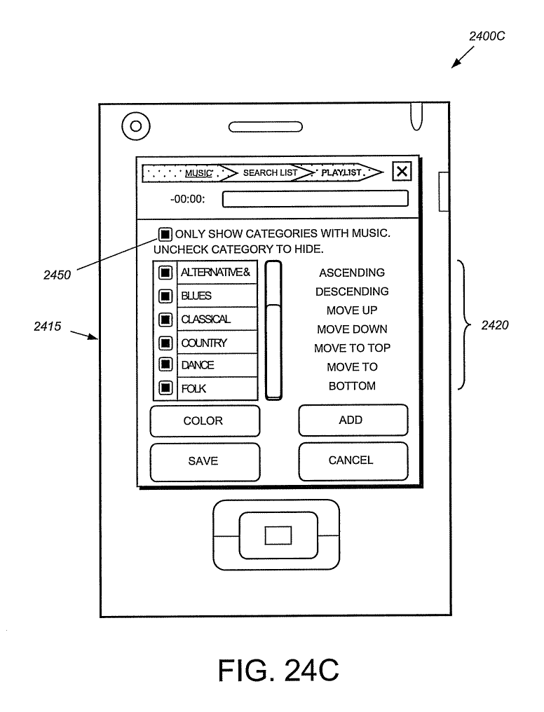

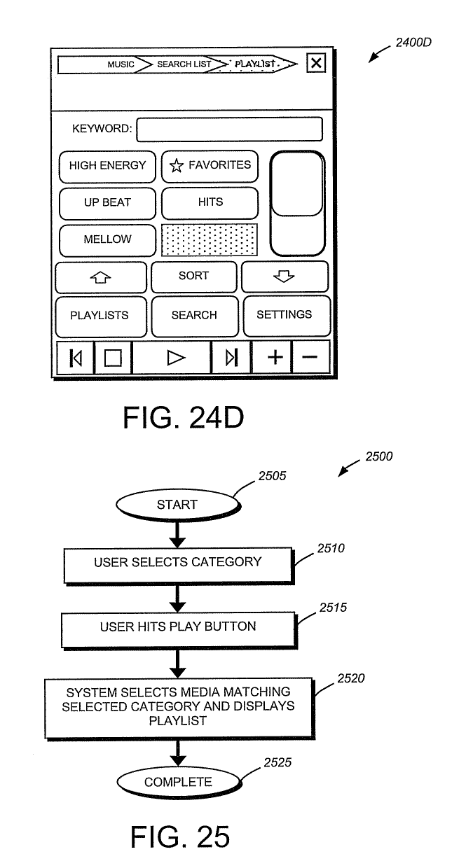

FIG. 23 is a flow chart detailing the steps of a procedure 2300 for modifying the display options for subcategories in accordance with an illustrative embodiment of the present invention. The procedure 2300 begins in step 2305 and continues to step 2310 or a user selects a settings button of a graphical user interface. This is illustrated in FIG. 24A for a settings 12405 may be selected. In response to sliding selecting the settings 12405 and menu is displayed as shown in FIG. 24B. A user may then select a subcategories button 2410 in step 2315. In response to selecting the subcategories button, a menu is displayed as shown in exemplary GUI window 2400C of FIG. 24C. The GUI window 2400C includes options for selecting subcategories 2415 as well as a number of selection buttons 2420 for moving the subcategories and orienting the buttons among themselves. Once a user has selected the display options in step 2320, the GUI then displays the new configuration in step 2325. This is illustrated in exemplary GUI window 2400D of FIG. 24D. The procedure 2300 then completes in step 2330.

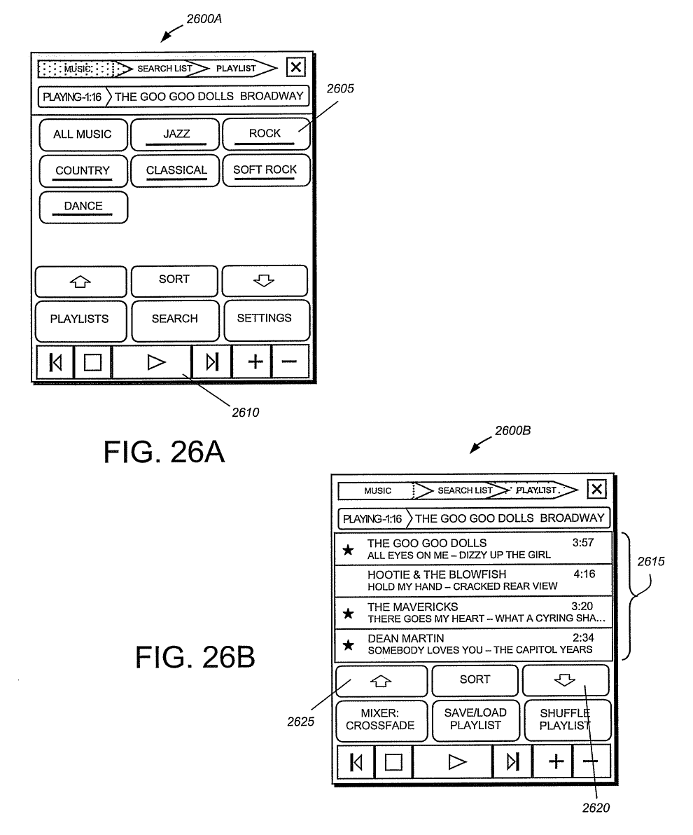

FIG. 25 is a flowchart detailing the steps of a procedure 2500 for generating a playlist and playing media by selecting a category in accordance with an illustrative embodiment of the present invention. The procedure 2500 begins in step 2505 and continues to step 2510 where a user selects a category button 2605 as shown in exemplary GUI window 2600A of FIG. 26A. The user then selects a play button 2610 in step 2515. In response, the system selects media matching the selected category and displays a playlist 2615, as shown in exemplary GUI window 2600B of FIG. 26B, of such matching media in step 2520. The procedure 2500 then completes in step 2525. Exemplary GUI window 2600B illustratively includes an up button 2625 and a down button 2620 to enable a user to scroll through the playlist.

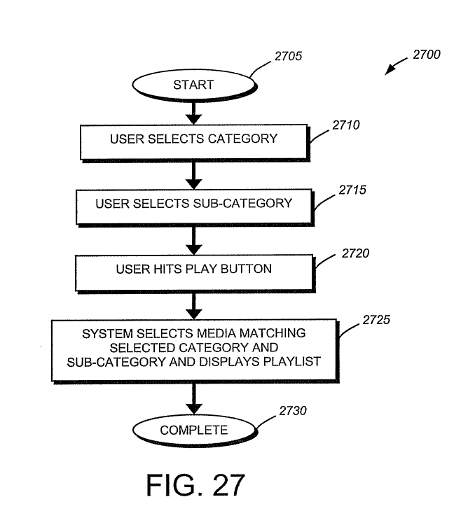

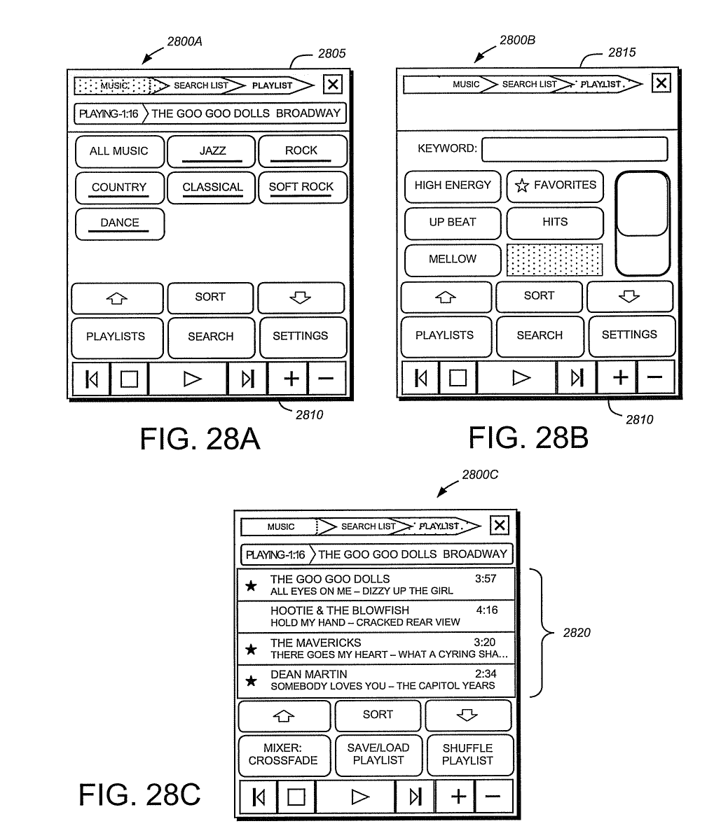

FIG. 27 is a flowchart detailing the steps of a procedure 2700 for playing media based on category and subcategory in accordance with an illustrative embodiment of the present invention. The procedure 2700 begins in step 2705 and continues to step 2710 where a user selects a category button 2805 as shown in exemplary GUI window 2800A of FIG. 28A. The user then selects a subcategory in step 2715. Exemplary GUI window 2800B illustrates exemplary subcategory buttons 2815. The user hits the play button 2810 in step 2720. In response, the system selects media matching the select a category and subcategory and displays the playlist in step 2725. An exemplary playlist 2820 is shown in GUI window 2800C of FIG. 28C. The procedure 2700 then completes in step 2730.

It should be noted that while the present invention has been described in reference to a media playback device, the principles of the present invention may be applied to any form of GUI. As such, the descriptions of media playback should be taken as exemplary only. Furthermore, it should be noted that the use of the term button with reference to GUI objects should be taken to include any GUI element, including, e.g., slider bars, radio dials, check boxes, etc. As such, the term button should be taken as exemplary only and should be interpreted to cover any type of GUI element. Additionally, for the purposes of this description, the term media should be taken to include any form of digital data including, e.g., music, video, photographs, games, text, PDF files, postscript files, etc.

What is claimed is:

1. A method for dynamically configuring a graphical user interface, the method comprising:
determining a set of characteristics associated with a display device;
configuring, without user intervention, the graphical user interface based on the determined set of characteristics; and
displaying the configured graphical user interface to a user on the display device.

2. The method of claim 1 wherein determining the set of characteristics comprises querying an operating system for a set of system parameters associated with the display device.

3. The method of claim 1 wherein the set of characteristics comprises a size of the display device.

4. The method of claim 1 wherein configuring the graphical user interface comprises modifying a set of buttons to be displayed based on the set of characteristics.

5. The method of claim 1 further comprising reconfiguring, based on the user modifying one or more display options, the graphical user interface.

6. The method of claim 5 wherein the display options comprises a list of categories to be displayed.

7. The method of claim 5 wherein the display options comprises a list of subcategories to be displayed.

8. A method for dynamically configuring a graphical user interface, the method comprising:
activating, by a user, one or more buttons of the graphical user interface;
recording a set of user information based on the activated buttons;
performing an analysis on the recorded user information; and
reconfiguring the graphical user interface based on the performed analysis

9. The method of claim 8 wherein the set of user information comprises a list of buttons selected.

10. The method of claim 8 wherein the set of user information comprises a list of media viewed.

11. The method of claim 8 wherein the set of user information comprises a timestamp of when a button was selected.

12. The method of claim 8 wherein reconfiguring the graphical user interface based on the performed analysis comprises relocating one of more buttons within the graphical user interface.

13. The method of claim 8 wherein reconfiguring the graphical user interface based on the performed analysis comprises modifying a set of search results based on the performed analysis

14. A method for dynamically configuring a graphical user interface, the method comprising:
selecting a category button of the graphical user interface;
selecting one or more subcategory buttons of the graphical user interface;
generating a playlist of media from at least one of a local database and a remote database;
displaying the generated playlist to a user; and
saving the generated playlist.

15. The method of claim 14 wherein saving the playlist comprises saving the playlist to a local device.

16. The method of claim 14 wherein saving the playlist comprises saving the playlist to a remote device.

17. The method of claim 14 wherein one of the one or more subcategory buttons comprises a sub genre button.

18. The method of claim 14 wherein the local database comprises media stored on a local device.

19. The method of claim 14 wherein the remote database comprises media stored on a media server.

20. The method of claim 14 wherein the saved playlist allows synchronization between a local and a remote device.
